(19) United States
(12) Patent Application Publication
(10) Pub. No.: US 2025/0138199 A1
(43) Pub. Date: May 1, 2025

(54) PEDESTRIAN PATH POSITIONING FOR THE ADAPTIVE GNSS DUTY CYCLE

(71) Applicant: SAMSUNG ELECTRONICS CO., LTD., Suwon-si (KR)

(72) Inventor: Jong Ki LEE, San Jose, CA (US)

(73) Assignee: SAMSUNG ELECTRONICS CO., LTD., Suwon-si (KR)

(21) Appl. No.: 18/785,889

(22) Filed: Jul. 26, 2024

Related U.S. Application Data
(60) Provisional application No. 63/546,813, filed on Nov. 1, 2023.

(51) Int. Cl. G01S 19/34; G01S 19/40; G01S 19/49

(52) U.S. Cl. CPC G01S 19/34; G01S 19/40; G01S 19/49

(57) ABSTRACT

Methods and systems for tracking a geographic position, including: determining a duty cycle associated with a global navigation satellite system (GNSS) based on a determined state of an electronic device, wherein the duty cycle comprises one or more first time periods in which a GNSS module is active, and one or more second time periods in which the GNSS module is inactive; obtaining GNSS information indicating a first position of the electronic device during the one or more first time periods; obtaining sensor information indicating a second position of the electronic device during the one or more second time periods, the second position being relative to the first position; and generating estimated missing path information during the one or more second time periods based on the GNSS information and the sensor information.

### CROSS-REFERENCE TO RELATED APPLICATION

This application claims the priority benefit under 35 U.S.C. § 119 (e) of U.S. Provisional Application No. 63/546,813, filed on Nov. 1, 2023, the disclosure of which is incorporated by reference in its entirety as if fully set forth herein.

### TECHNICAL FIELD

The disclosure generally relates to position tracking. More particularly, the subject matter disclosed herein relates to maintaining position tracking and its accuracy while using a global navigation satellite system (GNSS) according to an adaptive duty cycle.

### SUMMARY

Electronic devices, for example mobile devices or wearable devices such as smart watches and fitness trackers, may allow a user to perform position tracking in order to track a distance traveled by the user, or a trajectory traveled by the user. To perform position tracking, some electronic devices may include a receiver of a global navigation satellite system (GNSS), for example the Global Positioning System (GPS), the Globalnaya Navigatsionnaya Sputnikovaya Sistema (GLONASS), the BeiDou Navigation Satellite System, the Galileo GNSS system, the Quasi-Zenith Satellite System (QZSS), the Galileo GNSS, and the Korea Augmentation Satellite System (KASS). However, maintaining positioning accuracy may be difficult, for example in heavy multi-path environments. In addition, excessive use of the GNSS receiver may cause undesired power consumption, which may not be simply solved by increasing battery capacity.

To solve this problem, some position tracking approaches may operate the GNSS receiver according to a duty cycle which includes GNSS-on periods, in which the GNSS receiver is enabled or active, and GNSS-off periods, in which the GNSS receiver is disabled or inactive.

One issue with the above approaches is that they may significantly degrade the performance of the position tracking, because the GNSS receiver may be unable to provide GNSS positioning information during the GNSS-off period. For example, some of the above approaches may simply use a straight line between known positions determined according to the available GNSS information, which may lead to a significant error in the estimated distance and trajectory.

To overcome these issues, systems and methods are described herein which may allow the duty cycle of the GNSS receiver to be adaptively controlled based on a detected state of the electronic device. In addition, systems and methods are described herein which may allow the GNSS information provided by the GNSS receiver to be supplemented with sensor information provided by other sensors included in the electronic device. Further, systems and methods are described herein which may allow for improvement of the estimated distance or trajectory using machine learning (ML) models.

The above approaches may improve on previous methods because they may enable more accurate position tracking to be performed in certain situations, for example when the electronic device is determined to be in motion, and may enable refinement of the position tracking process using additional sensor information and ML trajectory correction. In addition, the above approaches may be implemented without modifications to the hardware of the electronic device.

In an embodiment, a method for tracking a geographic position is executed by at least one processor included in an electronic device and comprises: determining a duty cycle associated with a global navigation satellite system (GNSS) based on a determined state of the electronic device, wherein the duty cycle comprises one or more first time periods in which a GNSS module is active, and one or more second time periods in which the GNSS module is inactive; obtaining GNSS information indicating a first position of the electronic device during the one or more first time periods; obtaining sensor information indicating a second position of the electronic device during the one or more second time periods, the second position being relative to the first position; and generating estimated missing path information during the one or more second time periods based on the GNSS information and the sensor information.

In an embodiment, a system for tracking a geographic position comprises: an electronic device comprising at least one processor; a global navigation satellite system (GNSS) module configured to obtain GNSS information indicating a position of the electronic device; and a sensor module configured to obtain sensor information indicating the position of the electronic device. The at least one processor may be configured to: determine a duty cycle associated with the GNSS module based on a determined state of the electronic device, wherein the duty cycle comprises one or more first time periods in which the GNSS module is active, and one or more second time periods in which the GNSS module is inactive; obtain, using the GNSS module, GNSS information indicating a first position of the electronic device during the one or more first time periods; obtain, using a sensor module, sensor information indicating a second position of the electronic device during the one or more second time periods, the second position being relative to the first position; and generate estimated missing path information which during the one or more second time periods based on the GNSS information and the sensor information.

In an embodiment, a non-transitory computer-readable medium is configured to store instructions which, when executed by at least one processor of an electronic device for tracking a geographic position, causes the at least one processor to: determine a duty cycle associated with a global navigation satellite system (GNSS) based on the determined state, wherein the duty cycle comprises one or more first time periods in which a GNSS module is active, and one or more second time periods in which the GNSS module is inactive; obtain GNSS information indicating a first position of the electronic device during the one or more first time periods; obtain sensor information indicating a second position of the electronic device during the one or more second time periods, the second position being relative to the first position; and generate estimated missing path information during the one or more second time periods based on the GNSS information and the sensor information.

### BRIEF DESCRIPTION OF DRAWING

In the following section, the aspects of the subject matter disclosed herein will be described with reference to exemplary embodiments illustrated in the figures, in which:

FIG. 1A is a block diagram showing an example configuration of an electronic device including a global navigation satellite system (GNSS) module, according to embodiments.

FIG. 1B is a block diagram showing an example configuration of a sensor module included in an electronic device, according to embodiments.

FIG. 2 is a flowchart illustrating an example process for managing an adaptive duty cycle for a GNSS module, according to embodiments.

FIG. 3 is a diagram showing an example trajectory of an electronic device while a GNSS module is operated according to an adaptive duty cycle, according to embodiments.

FIG. 4 is a diagram illustrating a process for estimating a distance traveled by an electronic device, according to embodiments.

FIGS. 5A and 5B are diagrams illustrating processes for estimating a distance traveled by an electronic device, according to embodiments.

FIG. 6 is a diagram showing a process for estimating a trajectory of an electronic device, according to embodiments.

FIGS. 7A and 7B are diagrams showing processes for correcting an estimated trajectory of an electronic device, according to embodiments.

FIGS. 8A, 8B, and 8C are flow charts of processes for tracking a position of a user, according to embodiments.

FIG. 9 is a block diagram of an electronic device in a network environment, according to an embodiment.

FIG. 10 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

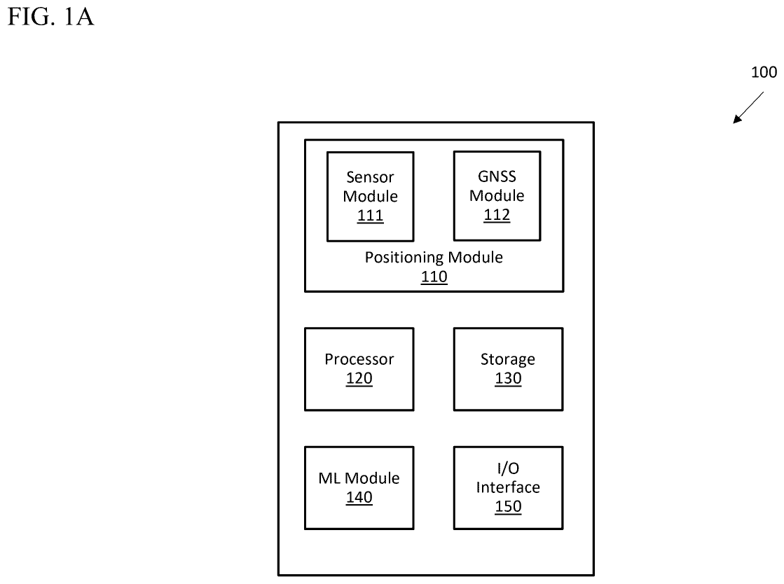

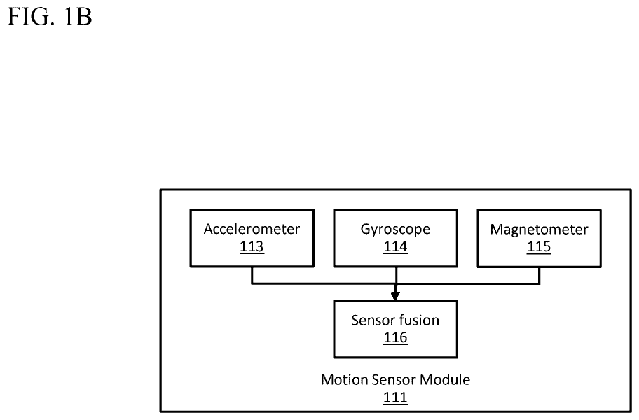

FIG. 1A is a block diagram showing an example of a configuration of an electronic device, according to embodiments. In embodiments, the electronic device 100 may be portable or mobile device, for example a smartphone, tablet computer, laptop computer, or wearable device such as a smart watch or fitness tracker, which may be used by a user to track a position of the user to determine path information corresponding to a path traveled by the user, for example a distance traveled by the user or a trajectory of the path traveled by the user. As shown in FIG. 1A, the electronic device 100 may include a positioning module 110, a processor 120, a storage 130, a machine-learning (ML) module 140, and an input/output (I/O) interface 150.

The positioning module 110 may include a sensor module 111 and a global navigation satellite system (GNSS) module 112. The sensor module 111 may include one or more sensors which may detect and measure sensor information about an environment of the electronic device 100 and events occurring in the environment. For example, in some embodiments the sensor information may indicate a relative position of the electronic device 100 with respect to a known position, for example a position determined based on GNSS information as described below. In embodiments, the one or more sensors may be micro-electromechanical system (MEMS) sensors, however embodiments are not limited thereto. An example of the sensor module 111 is described in more detail below with respect to FIG. 1B.

The GNSS module 112 may include a GNSS receiver configured to receive GNSS signals from a GNSS system, and to determine GNSS information such as a position of the electronic device 100 or the GNSS module 112 based on the GNSS signals. For example, the GNSS module 112 may correspond to or may operate according to at least one from among the Global Positioning System (GPS), the Globalnaya Navigatsionnaya Sputnikovaya Sistema (GLONASS), the BeiDou Navigation Satellite System, the Galileo GNSS, the Quasi-Zenith Satellite System (QZSS), the Korea Augmentation Satellite System (KASS), and any other GNSS system.

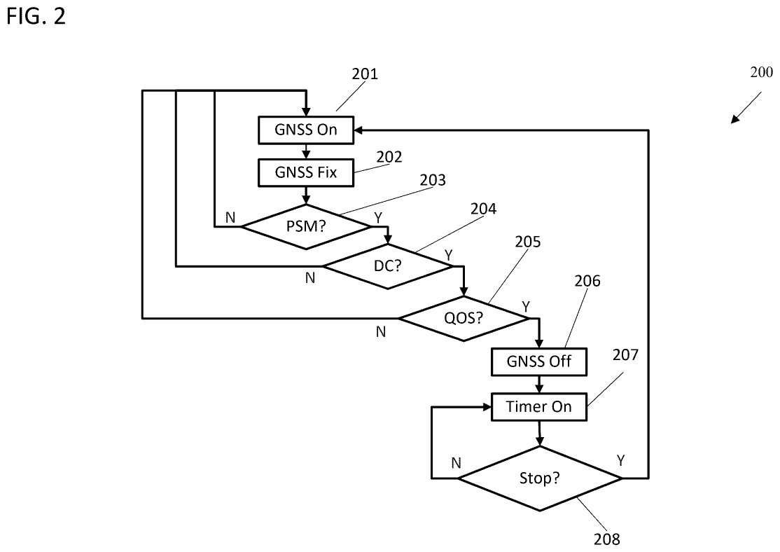

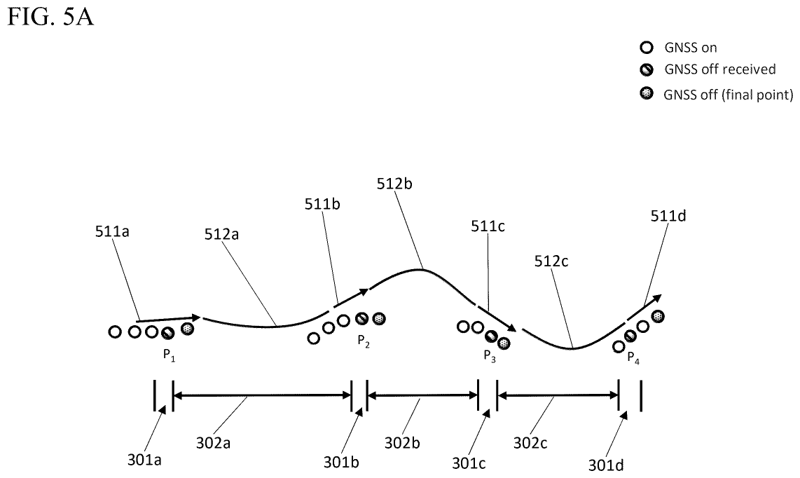

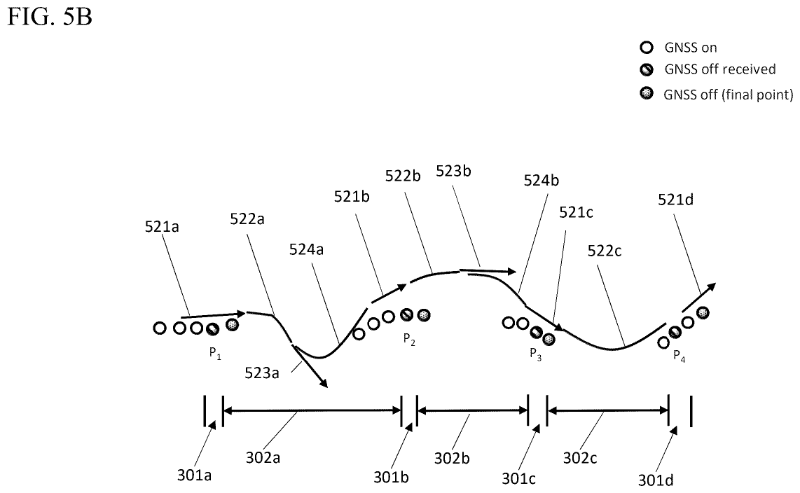

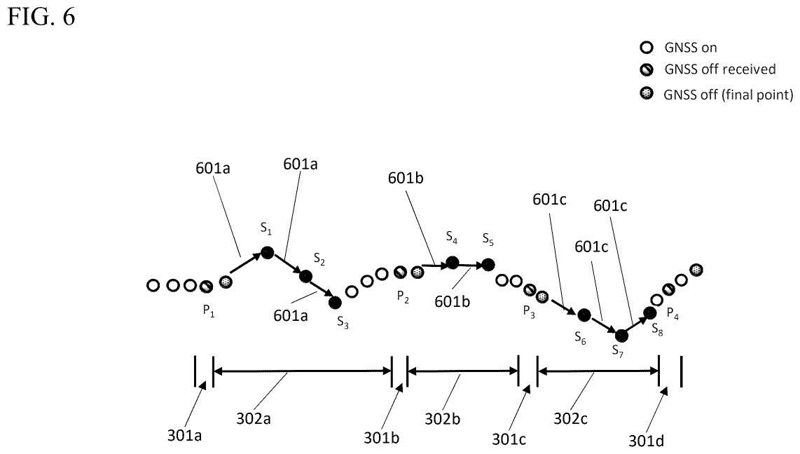

The processor 120 may control overall operations of the electronic device 100. For example, the processor 120 may enable or activate elements included in the electronic device 100, and may disable or deactivate elements included in the electronic device 100. For example, the processor 120 may activate and deactivate the GNSS module 112 according to an adaptive duty cycle, an example of which is discussed in greater detail below with respect to FIG. 2. In embodiments, the processor 120 may receive the sensor information and the GNSS information from the positioning module 110, and may use the sensor information and the GNSS information to determine or estimate the path information corresponding to the path traveled by the user, for example the distance traveled by the user or the trajectory of the path traveled by the user, examples of which are discussed in greater detail below with respect to FIGS. 5A, 5B, and 6.

The storage 130 may store the sensor information, the GNSS information, and the path information. In some embodiments, the storage 130 may store one or more ML models which may be used by the ML module 140.

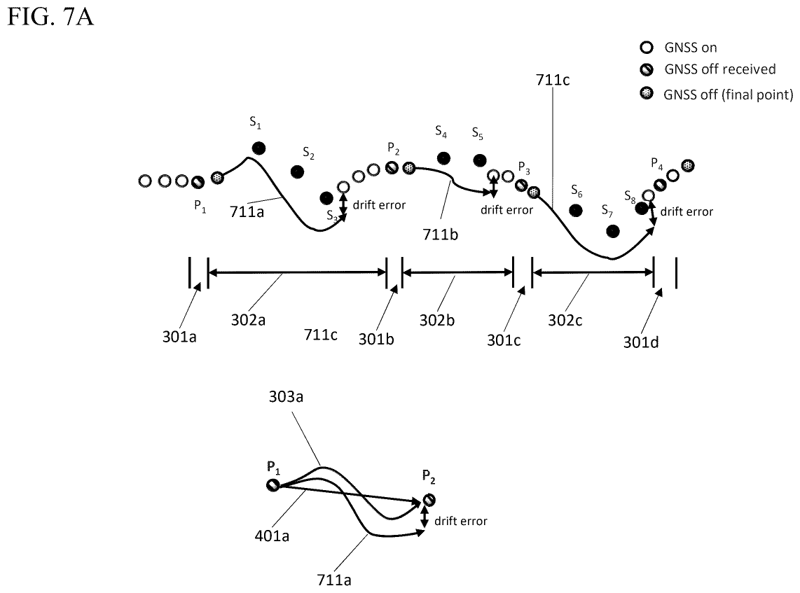

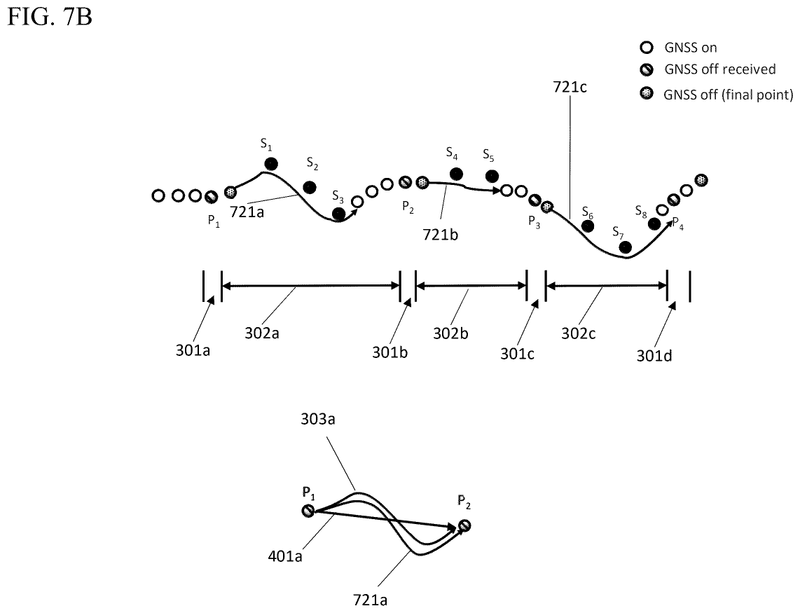

The ML module 140 may perform ML operations according to various ML models, for example to refine, improve, or correct the path error information. In embodiments, the ML module 140 may operate according to one of a plurality of ML models, which may be selected according to available sensor information. Example operations of the ML module 140 are described in greater detail below with respect to FIGS. 7A and 7B.

In embodiments, the I/O interface 150 may receive input information from the user, for example information for setting or modifying the adaptive duty cycle, and may provide output information to the user, for example the path information. For example, the I/O interface 150 may include a display such as a touchscreen display, and may include one or more buttons or keys which may be manipulated by the user, and may include speakers or other elements which may be used to convey information to the user. For example, after a user finishes an activity such as a hike or a workout, the electronic device 100 may generate path information corresponding to the workout, and may use the I/O interface 150 to provide the path information to the user, for example by displaying a number of steps or a visual trajectory on a touchscreen display. In addition, the I/O interface 150 may include elements such as wired or wireless transceivers which may be used to communicate with other devices, for example to transmit the path information to be used in the other devices.

Although FIG. 1A illustrates the elements included in the electronic device 100 as separate components, embodiments are not limited thereto, and the elements included in the electronic device may be combined or modified in any way. For example, in some embodiments the ML module 140 may be included in the processor 120, and the one or more ML models may be stored in the ML module 140.

FIG. 1B is a block diagram showing an example configuration of a motion sensor module included in an electronic device, according to embodiments. As shown in FIG. 1B, the one or more sensors included in the sensor module 111 may include an accelerometer 113, which may be configured to detect an acceleration of the electronic device 100, a gyroscope 114, which may be configured to detect at least one of an orientation and an angular velocity of the electronic device 100, and a magnetometer 115, which may detect variations in magnetic fields in the environment of the electronic device 100, for example variations in Earth's magnetic field in the environment of the user. However, embodiments are not limited thereto, and the sensor module 111 may include any sensors in any configuration or arrangement. In embodiments, the sensor module 111 may include a sensor fusion module 116, which may fuse information generated by the one or more sensors included in the sensor module 111 to generate the sensor information. For example, in some embodiments the sensor module 111 may be or may include an inertial measurement unit (IMU) such as a 6-axis IMU or a 9-axis IMU, and the sensor fusion module 116 may operate according to an algorithm to generate the sensor information, but embodiments are not limited thereto.

As discussed above, embodiments may allow the duty cycle of the GNSS module 112 to be adaptively controlled based on a detected state of the electronic device 100 in order to provide power savings. In addition, embodiments may allow the GNSS information provided by the GNSS module 112 to be supplemented with sensor information provided by the sensor module 111, and to be refined or corrected by one or more ML models of the ML module 140, in order to improve accuracy of path information generated by the electronic device 100 while the GNSS module is operated according to the adaptive duty cycle.

Accordingly, embodiments may operate according to three phases. For example, Phase 1 may relate to implementing the adaptive duty cycle, Phase 2 may relate to estimating a distance traveled based on the GNSS and sensor information, and Phase 3 may relate to estimating or reconstructing a trajectory based on the GNSS and sensor information and refining or improving the estimated or reconstructed trajectory using ML models. In some embodiments, Phase 1 may correspond to FIGS. 2 to 4, Phase 2 may correspond to FIGS. 5A and 5B, and Phase 3 may correspond to FIGS. 6, 7A, and 7B, as described below. However, embodiments are not limited thereto.

FIG. 2 is a flowchart illustrating an example process for managing an adaptive duty cycle for a GNSS module, according to embodiments. In embodiments, the process 200 may be performed by the electronic device 100 or any element included therein, for example the processor 120.

As shown in FIG. 2, at operation 201 the process 200 may include activating or enabling the GNSS module 112. At operation 202, the process 200 may include obtaining or achieving a GNSS fix using the GNSS module 112. For example, obtaining a GNSS fix may refer to collecting and processing GNSS signals until a position is determined with sufficient accuracy.

At operation 203, after the GNSS fix is achieved or obtained, the process 200 may include determining whether a power-saving mode (PSM) is enabled. Based on determining that the PSM is not enabled (N at operation 203), the process 200 may return to operation 201, and the GNSS module 112 may remain activated. For example, a user may desire to maintain position tracking accuracy at a highest level possible regardless of power consumption, and therefore may provide input to the electronic device 100 which disables the power-saving mode. Based on determining that the PSM mode is enabled (Y at operation 203), the process 200 may proceed to operation 204.

At operation 204, the process 200 may include determining whether the adaptive duty cycle is enabled. Based on determining that the adaptive duty cycle is not enabled (N at operation 204), the process 200 may return to operation 201, and the GNSS module 112 may remain activated. Based on determining that the PSM mode is enabled (Y at operation 204), the process 200 may proceed to operation 205.

At operation 205, the process 200 may include determining whether quality of service (QOS) measurements are sufficient to perform position tracking according to the adaptive duty cycle. In embodiments, the QOS measurements may include at least one of an expected vertical error (EVE) and an expected horizontal error (EHE). Based on determining that the QOS measurements are not sufficient to proceed (N at operation 205), the process 200 may return to operation 201, and the GNSS module 112 may remain activated. For example, if the QOS measurements indicate that expected error is high enough that using the adaptive duty cycle may unacceptably degrade position tracking performance, the electronic device 100 may cause the GNSS module to remain activated until the QOS measurements improve. Based on determining that the QOS measurements are sufficient to proceed (Y at operation 205), the process 200 may proceed to operation 206.

Accordingly, based on determining that the PSM is enabled, the adaptive duty cycle is enabled, and the QOS measurements are acceptable, at operation 206 the process 200 may include deactivating or disabling the GNSS module 112. At operation 207, the process 200 may include activating a duty cycle timer.

At operation 208, the process 200 may include determining whether to stop the duty cycle timer. Based on determining that the duty cycle timer should not be stopped (N at operation 208), the process 200 may include returning to operation 207 and allowing the duty cycle to continue to run, and based on determining that the duty cycle timer should be stopped (Y at operation 208), the process 200 may include returning to operation 201 and reactivating the GNSS module 112. For example, a value of the duty cycle timer may be compared to a threshold time, and the process 200 may include stopping the duty cycle timer and reactivating the GNSS module 112 based on determining that the threshold time has been reached.

In embodiments, the threshold time may be determined, set, or modified based on a state of the electronic device 100. For example, in some embodiments the processor 120 may use the sensor information generated by the sensor module 111 to determine a motion state of the electronic device 100 from among a plurality of possible motion states. For example, the plurality of possible motion states may include a static state in which the sensor information indicates that the electronic device 100 is not moving, a moving state in which the sensor information indicates that the electronic device 100 is moving, a moving-in-place state in which the sensor information indicates that the electronic device 100 is moving but a location of the electronic device is not changing (e.g., corresponding to a workout on a treadmill or exercise bicycle), and an unknown state in which the electronic device 100 is unable to determine the motion state based on the sensor information, or in which the sensor information is unavailable. In some embodiments, the motion state may indicate whether the electronic device 100 is being moved by a vehicle such as an automobile, an airplane, a boat, or a bicycle.

Therefore, according to embodiments, the process 200 may include adaptively controlling activation and deactivation of the GNSS module 112 based on a motion state of the electronic device 100. For example, based on the motion state being determined to be the static state, the electronic device 100 may set or modify the threshold time for the duty cycle timer to be a relatively long time, and based on the motion state being determined to be the moving state, the electronic device 100 may set or modify the threshold time to be a relatively short time. For example, the static state may correspond to a threshold time of five minutes, and the moving state may correspond to a threshold time of one minute or less, but embodiments are not limited thereto. In addition, based on the motion state indicating the electronic device is being moved by a vehicle, the electronic device may set or modify the threshold time to be even shorter. Further, in some embodiments the electronic device 100 may modify the threshold time, or simply return to operation 201, based on detecting a change in the state of the electronic device 100.

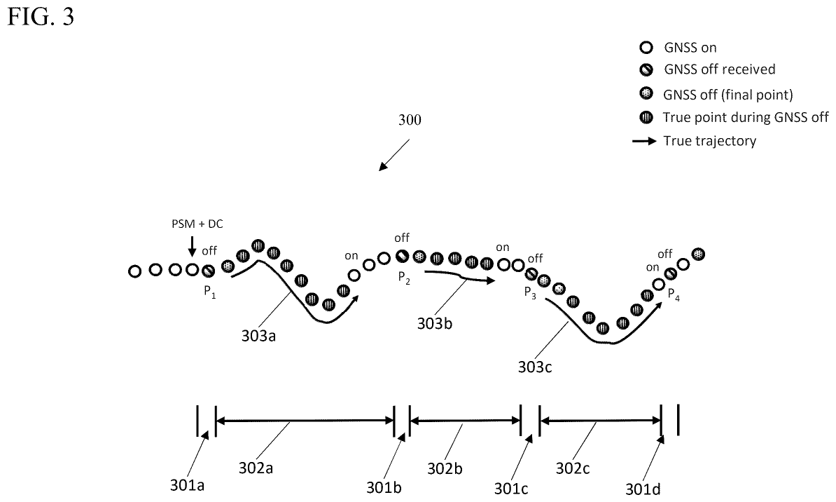

FIG. 3 is a diagram showing an example trajectory of an electronic device while a GNSS module is operated according to an adaptive duty cycle, according to embodiments. As shown in FIG. 3, trajectory 300 may include a plurality of time points which may be divided into a plurality of first time periods 301, for which GNSS information is available, and a plurality of second time periods 302, for which GNSS information is unavailable. For example, the first time periods 301a, 301b, 301c, and 301d, may include time points in which the GNSS module 112 is activated or enabled, and in which a GNSS fix has been achieved, so that the GNSS module 112 is able to provide accurate GNSS information. For example, GNSS information may be accurately captured at time point P₁, time point P₂, time point P₃, and time point P₄. The second time periods 302a, 302b, and 302c may include time points in which the GNSS module 112 is deactivated or disabled, and may also include time points in which the GNSS module 112 is activated or enabled, but has not yet achieved a GNSS fix, and is therefore unable to provide GNSS information. In embodiments, the first time periods 301 may correspond to operations 202 through 205 of the process 200, and the second time periods 302 may correspond to operations 206 through 208 of the process 200, but embodiments are not limited thereto. As shown in FIG. 3, the trajectory 300 may include missing path information 303a corresponding to second time period 302a, missing path information 303b corresponding to second time period 302b, and missing path information 303c corresponding to second time period 302c, which may be difficult to estimate or reconstruct based only on the GNSS information captured during the first time periods 301. Therefore, some embodiments, examples of which are described below, the sensor information may provide information about a relative position of the user during the second time periods 302 with respect to the position of the user during the first time periods 301, and may therefore be used to assist in estimating or reconstructing the missing path information 303.

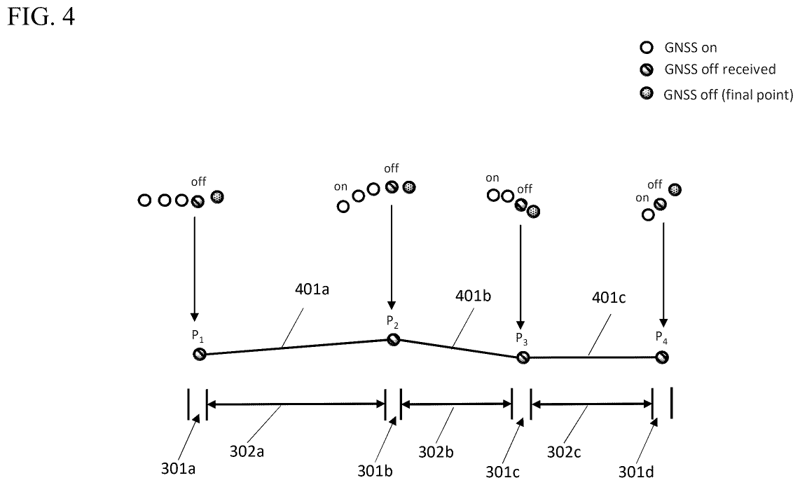

FIG. 4 is a diagram illustrating a process for estimating a distance traveled by an electronic device, according to embodiments. If the only information available is the GNSS information at the end points of each of the second time periods 302 (e.g., the GNSS information captured at time point P₁ in first time period 301a, time point P₂ in first time period 301b, time point P₃ in first time period 301c, and time point P₄ in first time period 301d), the distance traveled by the electronic device 100 may be approximated using straight lines 401a, 401b, and 401c between these points. As shown in FIG. 4, this may result in an estimated distance which is very different from the distance traveled in the trajectory 300 shown in FIG. 3. For example, the estimated distance may be only 30% of the true distance, but embodiments are not limited thereto. In addition, it may not be possible to estimate or reconstruct a trajectory based only on this information.

FIGS. 5A and 5B are diagrams illustrating processes for estimating a distance traveled by an electronic device, according to embodiments. As shown in FIGS. 5A and 5B, according to some embodiments the electronic device 100 may improve the estimated distance by supplementing the GNSS information corresponding to the time points P₁ to P₄ with sensor information generated or captured by the sensor module 111, for example heading information which indicates a heading of the electronic device. In embodiments, the estimated distance may be calculated using a Hermite interpolation curve, but embodiments are not limited thereto.

For example, as shown in FIG. 5A, based on heading information 511a indicating a heading of the electronic device 100 at the time point P₁ and heading information 511b indicating a heading of the electronic device 100 at the time point P₂, the electronic device 100 may generate a polynomial 512a which may be used to calculate or generate an estimated distance for second time period 302a which is more accurate than the estimated distance provided by straight line 401a. In a similar manner, the electronic device 100 may generate polynomials 512b and 512c based on heading information 511b, 511c, and 511d, which may be used to generate estimated distances corresponding to second time periods 302b and 302c.

As another example, as shown in FIG. 5B, based on heading information 521a indicating a heading of the electronic device 100 at the time point P₁, heading information 523a at a time point during the second time period 302a, and heading information 521b indicating a heading of the electronic device 100 at the time point P₂, the electronic device 100 may generate piecewise polynomials 522a and 524a, which provide an estimated distance for second time period 302a which is more accurate than the estimated distance provided by straight line 401a and is also more accurate than the estimated distance provided by polynomial 521a. In a similar manner, the electronic device 100 may generate piecewise polynomials 522b, 524b, and 522c based on heading information 521b, 523b, 521c, and 521d, which may be used to generate estimated distances corresponding to second time periods 302b and 302c.

FIG. 6 is a diagram illustrating a process for estimating a trajectory of an electronic device, according to embodiments. As shown in FIG. 6, according to some embodiments the electronic device 100 may improve the estimated distance by supplementing the GNSS information corresponding to the time points P₁ to P₄ with sensor information generated or captured by the sensor module 111, for example heading information which indicates a heading of the electronic device and step information corresponding to steps taken by the user.

For example, as shown in FIG. 6, the sensor information may be used to detect steps which occur at time points S₁, S₂, and S₃ in second time period 302a, steps which occur at time points S₄ and S₅ in second time period 302b, and steps which occur at time points S₆, S₇, and S₈ in second time period 302c. Then, the electronic device 100 may use step information corresponding to the steps to generate a reconstructed or estimated trajectory.

For example, the electronic device 100 may store a calibrated step length corresponding to the user, which may be determined in advance based on a step-length calibration process performed by a user. The calibrated step length may indicate, for example, an average length of each step taken by the user. The electronic device 100 may reconstruct a trajectory of the electronic device 100 based on heading information 601a indicating a heading of the electronic device 100 at the time points P₁, S₁, S₂, and S₃, heading information 601b indicating a heading of the electronic device 100 at the time points P₂, S₄, S₅, and S₆, and heading information 601c indicating a heading of the electronic device 100 at the time points P₃, S₆, S₇, and S₈, along with the step information including the calibrated step length corresponding to time points S₁ to S₈.

As another example, the electronic device 100 may estimate a speed of the user based on a frequency of the steps detected at time points S₁ to S₈. Then, the electronic device 100 may reconstruct a trajectory of the electronic device 100 based on heading information 601a indicating a heading of the electronic device 100 at the time points P₁, S₁, S₂, and S₃, heading information 601b indicating a heading of the electronic device 100 at the time points P₂, S₄, S₅, and S₆, and heading information 601c indicating a heading of the electronic device 100 at the time points P₃, S₆, S₇, and S₈, along with the step information including the estimated speed corresponding to time points S₁ to S₈.

FIGS. 7A and 7B are diagrams showing processes for correcting an estimated trajectory of an electronic device, according to embodiments. In some embodiments, the trajectory calculated according to FIG. 6, which may be referred to as a dead-reckoning trajectory, may have errors caused by sensor drift error which occurs in the one or more sensors of the sensor module 111.

For example, as shown in FIG. 7A, step information corresponding to the steps detected at time points S₁, S₂, and S₃ may be used to calculate or generate an estimated trajectory 711a for the second time period 302a. However, errors in the sensor information may cause a drift error between the estimated trajectory 711a and the true trajectory of the missing path information 303a for the second time period 302a. As shown in FIG. 7A, similar errors may be present in estimated trajectory 711b corresponding to second time period 302b, and estimated trajectory 711c corresponding to second time period 302c.

Therefore, in some embodiments the electronic device 100 may use an ML model to correct the drift error. For example, as shown in FIG. 7B, the estimated trajectory 711a may be provided to the ML module 140, which may apply a ML model to the estimated trajectories 711a in order generate corrected trajectory 721a. As shown in FIG. 7B, the corrected trajectory 721a may be closer to the true trajectory for the missing path information 303a for second time period 302a than the estimated trajectory 711a. The ML module 140 may similarly be used to generate corrected trajectory 721b corresponding to second time period 302b based on estimated trajectory 711b, and corrected trajectory 721c corresponding to second time period 302c based on estimated trajectory 711c.

In embodiments, the ML model may be or may include a supervised regression ML model which may be trained using a training set that includes true trajectories and corresponding drifted trajectories generated based on drifted sensor information. Regression model may refer to a statistical method which attempts to determine the relationship between one variable and a series of other variables.

In some embodiments, a goal of the supervised regression ML model may be to find how the estimated trajectory has drifted away based on provided features. Table 1 below shows an example of features which may be extracted from the available GNSS information and motion sensor information. However, embodiments are not limited to the example shown in Table 1.

TABLE 1

| # | Feature | Unit |
|---|---|---|
| 1 | Distance change between two points | meter |
| 2 | Height change between two points | meter |
| 3 | Course change between two points | degree |
| 4 | Speed change between two points | meter/sec |
| 5 | Heading information | degree |
| 6 | User step frequency | unitless |

In some embodiments, a plurality of ML models may be constructed using different possible combinations available features.

In some embodiments, complex ML models (e.g., ML models having a degree greater than 1), may be generated from simple ML models (e.g., ML models having degree equal to 1).

For example, for three features with degree 1, four coefficients with a bias term (e.g., [x0, x1, x2]), or three coefficients without a bias term (e.g., [1,x0, x1, x2]) may be used. For three features with degree 2, ten coefficients with a bias term (e.g., [x0, x1, x2, x02,x0x1,x0x2,x12,x1x2,x22]) or nine coefficients without a bias term (e.g., [1,x0, x1, x2, x02,x0x1,x0x2,x12,x1x2,x22]) may be used.

In embodiments, a test score may be calculated for each ML model by comparing results generated by the model to a test dataset. In embodiments, one or more ML models may be selected based on the training and test score.

In some embodiments, the electronic device 100 may adaptively select an appropriate ML model based on the GNSS information and sensor information that is available. For example, based on information corresponding to one or more of the features discussed above are not available to the ML module 140, then an ML model which does not use those features as input may be selected to be used by the ML module 140 to generate corrected trajectories.

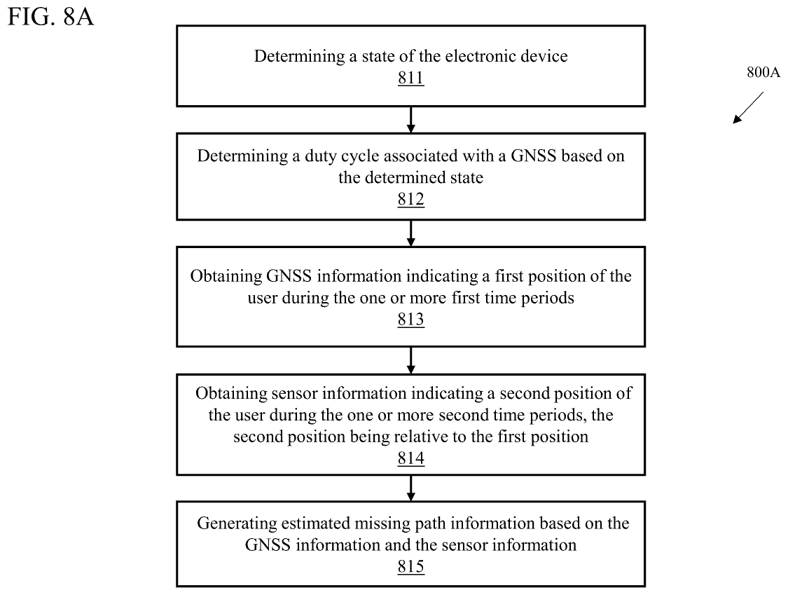

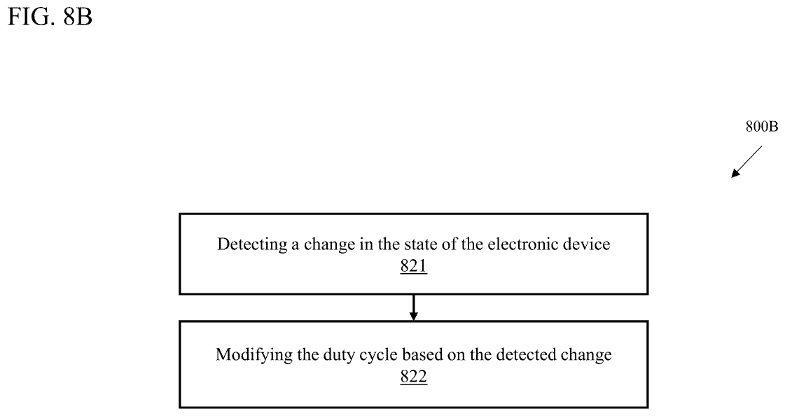

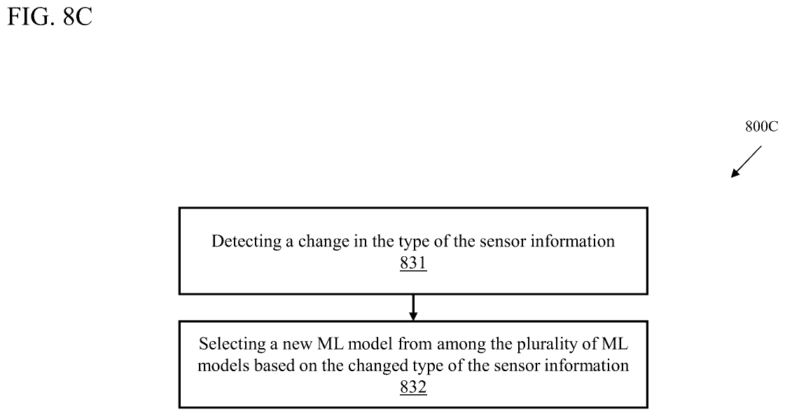

FIGS. 8A, 8B, and 8C are flow charts of processes for tracking a position of a user, according to embodiments.

FIG. 8A is a flow chart of process 800A for tracking a geographic position. In some embodiments, the geographic position may correspond to a position of a user, but embodiments are not limited thereto. In some implementations, one or more process blocks of FIG. 8A may be performed by one or more of the elements discussed above, for example one or more of the electronic device 100 and the elements included therein.

As shown in FIG. 8A, at operation 811 the process 800A may include determining a state of the electronic device. In some embodiments, the electronic device may correspond to the electronic device 100 discussed above, and the state may correspond to the motion state discussed above. In some embodiments, the state of the electronic device may be determined by a different device, which may inform the electronic device of the state, or the state may be determined another way, but embodiments are not limited thereto.

As further shown in FIG. 8A, at operation 812 the process 800A may include determining a duty cycle associated with a GNSS based on the determined state. In embodiments, the duty cycle may be associated with a GNSS module, which may for example correspond to the GNSS module 112, but embodiments are not limited thereto. In embodiments, the duty cycle may include one or more first time periods in which the GNSS module is active, and one or more second time periods in which the GNSS module is inactive. In embodiments, the duty cycle may correspond to the adaptive duty cycle discussed above, the one or more first time periods may correspond to the first time periods 301 and one or more second time periods may correspond to the second time periods 302.

As further shown in FIG. 8A, at operation 813 the process 800A may include obtaining GNSS information indicating a first position of the electronic device during the one or more first time periods. In embodiments, the GNSS information may be obtained using the GNSS module, but embodiments are not limited thereto.

As further shown in FIG. 8A, at operation 814 the process 800A may include obtaining sensor information indicating a second position of the electronic device during the one or more second time periods, the second position being relative to the first position. In embodiments, the sensor information may be obtained using a sensor module, but embodiments are not limited thereto. In embodiments, the sensor module may correspond to the sensor module 111.

As further shown in FIG. 8A, at operation 815 the process 800A may include generating estimated missing path information during the one or more second time periods based on the GNSS information and the sensor information. For example, the estimated missing path information may be information which indicates an estimation about a missing path corresponding to the one or more second time periods.

In embodiments, the estimated missing path information may indicate at least one from among a distance traveled by the electronic device during the one or more second time periods, and a trajectory of the electronic device during the one or more second time periods, but embodiments are not limited thereto.

In embodiments, the state may include at least one from among a first state in which the electronic device is determined to be not moving, a second state in which the electronic device is determined to be moving, a third state in which the electronic device is determined to be moving in place, and a fourth state in which it is unknown whether the electronic device is moving.

In embodiments, the sensor module may include at least one from among an accelerometer, a gyroscope, and a magnetometer. In embodiments, the accelerometer may correspond to the accelerometer 113, the gyroscope may correspond to the gyroscope 114, and the magnetometer may correspond to the magnetometer 115.

In embodiments, the sensor information may indicate a heading of the electronic device, and the estimated missing path information may include a polynomial curve which indicates the distance traveled by the electronic device during the one or more second time periods. In embodiments, the sensor information may correspond to heading information 511b, 511c, and 511d discussed above, and the polynomial may correspond to polynomials 512b and 512c discussed above.

In embodiments, the sensor information may indicate a heading of the electronic device, and the estimated missing path information may include at least one of a polynomial curve and a plurality of piecewise polynomial curves which indicate the distance traveled by the electronic device during the one or more second time periods. In embodiments, the sensor information may correspond to the heading information 521b, 523b, 521c, and 521d discussed above, and the piecewise polynomials may correspond to piecewise polynomials 522b, 524b, and 522c discussed above.

In embodiments, the sensor information may indicate at least one of a distance traveled by and a speed of the electronic device at one or more time points within the one or more second time periods, and a heading of the electronic device at the one or more time points, and the estimated missing path information may include an estimated trajectory of the electronic device during the one or more second time periods. In embodiments, the sensor information may correspond to at least one of the step information including the calibrated step length and the detected frequency of the steps discussed above, and the estimated trajectory may correspond to the estimated trajectories 711a, 711b, and 711c discussed above.

In embodiments, the estimated missing path information may be generated by providing the GNSS information and the sensor information to a ML model which is trained to correct a drift in the sensor information.

In embodiments, the ML model may be selected based on a type of the sensor information from among a plurality of ML models which are trained to correct the drift in the sensor information. In embodiments, selecting the ML model based on the type of the sensor information may correspond to the selection of the ML model based on the available sensor information as discussed above.

FIG. 8B is a flow chart of process 800B for tracking a position of a user. In some implementations, one or more process blocks of FIG. 8B may be performed by one or more of the elements discussed above, for example one or more of the electronic device 100 and the elements included therein.

As shown in FIG. 8B, at operation 821 the process 800B may include detecting a change in the state of the electronic device.

As further shown in FIG. 8B, at operation 822 the process 800B may include modifying the duty cycle based on the detected change.

FIG. 8C is a flow chart of process 800C for tracking a position of a user. In some implementations, one or more process blocks of FIG. 8C may be performed by one or more of the elements discussed above, for example one or more of the electronic device 100 and the elements included therein.

As shown in FIG. 8C, at operation 831, the process 800C may include detecting a change in the type of the sensor information.

As further shown in FIG. 8C, at operation 832, the process 800C may include selecting a new ML model from among the plurality of ML models based on the changed type of the sensor information.

Although FIGS. 8A to 8C show example blocks of processes 800A, 800B, and 800C, in some implementations, processes 800A, 800B, and 800C may include additional blocks, fewer blocks, different blocks, or differently arranged blocks than those depicted in FIGS. 8A to 8C. Additionally, or alternatively, two or more of the blocks of processes 800A, 800B, and 800C may be performed in parallel.

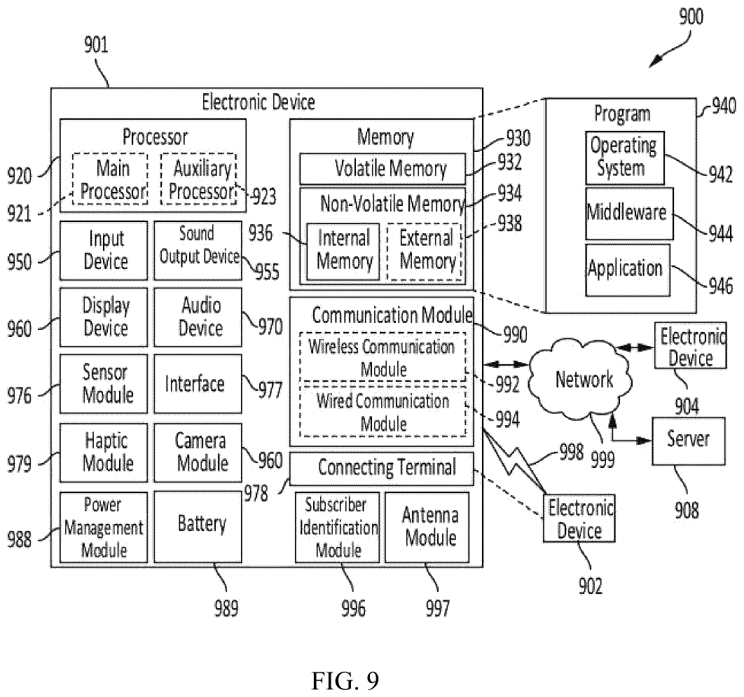

FIG. 9 is a block diagram of an electronic device in a network environment 900, according to an embodiment.

Referring to FIG. 9, an electronic device 901 in a network environment 900 may communicate with an electronic device 902 via a first network 998 (e.g., a short-range wireless communication network), or an electronic device 904 or a server 908 via a second network 999 (e.g., a long-range wireless communication network). The electronic device 901 may communicate with the electronic device 904 via the server 908. The electronic device 901 may include a processor 920, a memory 930, an input device 950, a sound output device 955, a display device 960, an audio module 970, a sensor module 976, an interface 977, a haptic module 979, a camera module 980, a power management module 988, a battery 989, a communication module 990, a subscriber identification module (SIM) card 996, or an antenna module 997. In one embodiment, at least one (e.g., the display device 960 or the camera module 980) of the components may be omitted from the electronic device 901, or one or more other components may be added to the electronic device 901. Some of the components may be implemented as a single integrated circuit (IC). For example, the sensor module 976 (e.g., a fingerprint sensor, an iris sensor, or an illuminance sensor) may be embedded in the display device 960 (e.g., a display).

The processor 920 may execute software (e.g., a program 940) to control at least one other component (e.g., a hardware or a software component) of the electronic device 901 coupled with the processor 920 and may perform various data processing or computations.

As at least part of the data processing or computations, the processor 920 may load a command or data received from another component (e.g., the sensor module 976 or the communication module 990) in volatile memory 932, process the command or the data stored in the volatile memory 932, and store resulting data in non-volatile memory 934. The processor 920 may include a main processor 921 (e.g., a central processing unit (CPU) or an application processor (AP)), and an auxiliary processor 923 (e.g., a graphics processing unit (GPU), an image signal processor (ISP), a sensor hub processor, or a communication processor (CP)) that is operable independently from, or in conjunction with, the main processor 921. Additionally or alternatively, the auxiliary processor 923 may be adapted to consume less power than the main processor 921, or execute a particular function. The auxiliary processor 923 may be implemented as being separate from, or a part of, the main processor 921.

The auxiliary processor 923 may control at least some of the functions or states related to at least one component (e.g., the display device 960, the sensor module 976, or the communication module 990) among the components of the electronic device 901, instead of the main processor 921 while the main processor 921 is in an inactive (e.g., sleep) state, or together with the main processor 921 while the main processor 921 is in an active state (e.g., executing an application). The auxiliary processor 923 (e.g., an image signal processor or a communication processor) may be implemented as part of another component (e.g., the camera module 980 or the communication module 990) functionally related to the auxiliary processor 923.

The memory 930 may store various data used by at least one component (e.g., the processor 920 or the sensor module 976) of the electronic device 901. The various data may include, for example, software (e.g., the program 940) and input data or output data for a command related thereto. The memory 930 may include the volatile memory 932 or the non-volatile memory 934. Non-volatile memory 934 may include internal memory 936 and/or external memory 938.

The program 940 may be stored in the memory 930 as software, and may include, for example, an operating system (OS) 942, middleware 944, or an application 946.

The input device 950 may receive a command or data to be used by another component (e.g., the processor 920) of the electronic device 901, from the outside (e.g., a user) of the electronic device 901. The input device 950 may include, for example, a microphone, a mouse, or a keyboard.

The sound output device 955 may output sound signals to the outside of the electronic device 901. The sound output device 955 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 960 may visually provide information to the outside (e.g., a user) of the electronic device 901. The display device 960 may include, for example, a display, a hologram device, or a projector and control circuitry to control a corresponding one of the display, hologram device, and projector. The display device 960 may include touch circuitry adapted to detect a touch, or sensor circuitry (e.g., a pressure sensor) adapted to measure the intensity of force incurred by the touch.

The audio module 970 may convert a sound into an electrical signal and vice versa. The audio module 970 may obtain the sound via the input device 950 or output the sound via the sound output device 955 or a headphone of an external electronic device 902 directly (e.g., wired) or wirelessly coupled with the electronic device 901.

The sensor module 976 may detect an operational state (e.g., power or temperature) of the electronic device 901 or an environmental state (e.g., a state of a user) external to the electronic device 901, and then generate an electrical signal or data value corresponding to the detected state. The sensor module 976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 977 may support one or more specified protocols to be used for the electronic device 901 to be coupled with the external electronic device 902 directly (e.g., wired) or wirelessly. The interface 977 may include, for example, a high-definition multimedia interface (HDMI), a universal serial bus (USB) interface, a secure digital (SD) card interface, or an audio interface.

A connecting terminal 978 may include a connector via which the electronic device 901 may be physically connected with the external electronic device 902. The connecting terminal 978 may include, for example, an HDMI connector, a USB connector, an SD card connector, or an audio connector (e.g., a headphone connector).

The haptic module 979 may convert an electrical signal into a mechanical stimulus (e.g., a vibration or a movement) or an electrical stimulus which may be recognized by a user via tactile sensation or kinesthetic sensation. The haptic module 979 may include, for example, a motor, a piezoelectric element, or an electrical stimulator.

The camera module 980 may capture a still image or moving images. The camera module 980 may include one or more lenses, image sensors, image signal processors, or flashes. The power management module 988 may manage power supplied to the electronic device 901. The power management module 988 may be implemented as at least part of, for example, a power management integrated circuit (PMIC).

The battery 989 may supply power to at least one component of the electronic device 901. The battery 989 may include, for example, a primary cell which is not rechargeable, a secondary cell which is rechargeable, or a fuel cell.

The communication module 990 may support establishing a direct (e.g., wired) communication channel or a wireless communication channel between the electronic device 901 and the external electronic device (e.g., the electronic device 902, the electronic device 904, or the server 908) and performing communication via the established communication channel. The communication module 990 may include one or more communication processors that are operable independently from the processor 920 (e.g., the AP) and supports a direct (e.g., wired) communication or a wireless communication. The communication module 990 may include a wireless communication module 992 (e.g., a cellular communication module, a short-range wireless communication module, or a global navigation satellite system (GNSS) communication module) or a wired communication module 994 (e.g., a local area network (LAN) communication module or a power line communication (PLC) module). A corresponding one of these communication modules may communicate with the external electronic device via the first network 998 (e.g., a short-range communication network, such as BLUETOOTH™, wireless-fidelity (Wi-Fi) direct, or a standard of the Infrared Data Association (IrDA)) or the second network 999 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 992 may identify and authenticate the electronic device 901 in a communication network, such as the first network 998 or the second network 999, using subscriber information (e.g., international mobile subscriber identity (IMSI)) stored in the subscriber identification module 996.

The antenna module 997 may transmit or receive a signal or power to or from the outside (e.g., the external electronic device) of the electronic device 901. The antenna module 997 may include one or more antennas, and, therefrom, at least one antenna appropriate for a communication scheme used in the communication network, such as the first network 998 or the second network 999, may be selected, for example, by the communication module 990 (e.g., the wireless communication module 992). The signal or the power may then be transmitted or received between the communication module 990 and the external electronic device via the selected at least one antenna.

Commands or data may be transmitted or received between the electronic device 901 and the external electronic device 904 via the server 908 coupled with the second network 999. Each of the electronic devices 902 and 904 may be a device of a same type as, or a different type, from the electronic device 901. All or some of operations to be executed at the electronic device 901 may be executed at one or more of the external electronic devices 902, 904, or 908. For example, if the electronic device 901 should perform a function or a service automatically, or in response to a request from a user or another device, the electronic device 901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 901. The electronic device 701 may provide the outcome, with or without further processing of the outcome, as at least part of a reply to the request. To that end, a cloud computing, distributed computing, or client-server computing technology may be used, for example.

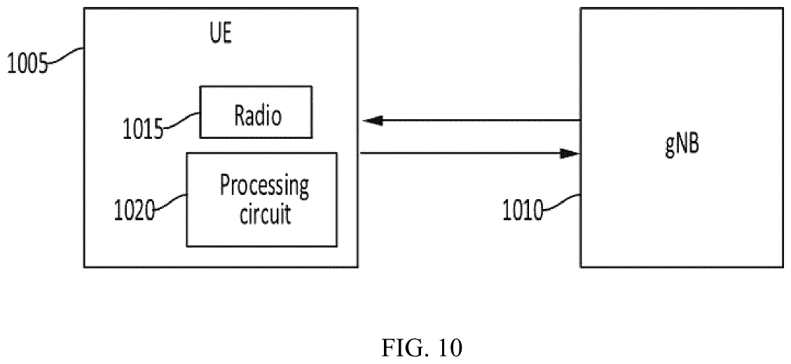

FIG. 10 shows a system including a UE 1005 and a gNB 1010, in communication with each other. The UE may include a radio 1015 and a processing circuit (or a means for processing) 1020, which may perform various methods disclosed herein, e.g., the method illustrated in FIGS. 2 and 8A-8C. For example, the processing circuit 1020 may receive, via the radio 1015, transmissions from the network node (gNB) 1010, and the processing circuit 1020 may transmit, via the radio 1015, signals to the gNB 1010.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for tracking a geographic position comprising:
determining a duty cycle associated with a global navigation satellite system (GNSS) based on a determined state of an electronic device, wherein the duty cycle comprises one or more first time periods in which a GNSS module is active, and one or more second time periods in which the GNSS module is inactive;
obtaining GNSS information indicating a first position of the electronic device during the one or more first time periods;
obtaining sensor information indicating a second position of the electronic device during the one or more second time periods, the second position being relative to the first position; and
generating estimated missing path information during the one or more second time periods, based on the GNSS information and the sensor information.

2. The method of claim 1, wherein the estimated missing path information comprises one or more of a distance travelled by the electronic device during the one or more second time periods and a trajectory of the electronic device during the one or more second time periods.

3. The method of claim 1, wherein the state comprises at least one from among a first state in which the electronic device is determined to be not moving, a second state in which the electronic device is determined to be moving, a third state in which the electronic device is determined to be moving in place, and a fourth state in which it is unknown whether the electronic device is moving.

4. The method of claim 1, further comprising:
detecting a change in the state of the electronic device; and
modifying the duty cycle based on the detected change.

5. The method of claim 1, wherein a sensor module used to obtain the sensor information comprises at least one from among an accelerometer, a gyroscope, and a magnetometer.

6. The method of claim 1, wherein the sensor information indicates a heading of the electronic device, and
wherein the estimated missing path information comprises a polynomial curve which indicates a distance traveled by the electronic device during the one or more second time periods.

7. The method of claim 1, wherein the sensor information indicates a heading of the electronic device at one or more time points within the one or more second time periods, and
wherein the estimated missing path information comprises a plurality of piecewise polynomial curves which indicate a distance traveled by the electronic device during the one or more second time periods.

8. The method of claim 1, wherein the sensor information indicates a distance traveled by the electronic device at one or more time points within the one or more second time periods, and a heading of the electronic device at the one or more time points, and
wherein the estimated missing path information comprises an estimated trajectory of the electronic device during the one or more second time periods.

9. The method of claim 1, wherein the sensor information indicates a speed of the electronic device at one or more time points within the one or more second time periods, and a heading of the electronic device at the one or more time points, and
wherein the estimated missing path information comprises an estimated trajectory of the electronic device during the one or more second time periods.

10. The method of claim 1, wherein the estimated missing path information is generated by providing the GNSS information and the sensor information to a machine learning (ML) model which is trained to correct a drift in the sensor information.

11. The method of claim 10, wherein the ML model is selected based on a type of the sensor information from among a plurality of ML models which are trained to correct the drift in the sensor information.

12. The method of claim 11, further comprising:
detecting a change in the type of the sensor information; and
selecting a new ML model from among the plurality of ML models based on the changed type of the sensor information.

13. A system for tracking a geographic position, the system comprising:
an electronic device comprising at least one processor;
a global navigation satellite system (GNSS) module configured to obtain GNSS information indicating a position of the electronic device; and
a sensor module configured to obtain sensor information indicating a relative position of the electronic device,
wherein the at least one processor is configured to:
determine a duty cycle associated with the GNSS module based on a determined state of the electronic device, wherein the duty cycle comprises one or more first time periods in which the GNSS module is active, and one or more second time periods in which the GNSS module is inactive;
obtain, using the GNSS module, GNSS information indicating a first position of the electronic device during the one or more first time periods;
obtain, using the sensor module, sensor information indicating a second position of the electronic device during the one or more second time periods, the second position being relative to the first position; and
generate estimated missing path information during the one or more second time periods, based on the GNSS information and the sensor information.

14. The system of claim 13, wherein the estimated missing path information comprises one or more of a distance travelled by the electronic device during the one or more second time periods and a trajectory of the electronic device during the one or more second time periods.

15. The system of claim 13, wherein the state comprises at least one from among a first state in which the electronic device is determined to be not moving, a second state in which the electronic device is determined to be moving, a third state in which the electronic device is determined to be moving in place, and a fourth state in which it is unknown whether the electronic device is moving.

16. The system of claim 13, wherein the sensor information indicates a heading of the electronic device, and
wherein the estimated missing path information comprises a polynomial curve which indicates a distance traveled by the electronic device during the one or more second time periods.

17. The system of claim 13, wherein the sensor information indicates a heading of the electronic device at one or more time points within the one or more second time periods, and
wherein the estimated missing path information comprises a plurality of piecewise polynomial curves which indicate a distance traveled by the electronic device during the one or more second time periods.

18. The system of claim 13, wherein the sensor information indicates a distance traveled by the electronic device or a speed of the electronic device at one or more time points within the one or more second time periods, and a heading of the electronic device at the one or more time points, and
wherein the estimated missing path information comprises an estimated trajectory of the electronic device during the one or more second time periods.

19. The system of claim 13, wherein the estimated missing path information is generated by providing the GNSS information and the sensor information to a machine learning (ML) model which is trained to correct a drift in the sensor information, and
wherein the ML model is selected based on a type of the sensor information from among a plurality of ML models which are trained to correct the drift in the sensor information, and
wherein the at least one processor is further configured to:
detect a change in the type of the sensor information; and
select a new ML model from among the plurality of ML models based on the changed type of the sensor information.

20. A non-transitory computer-readable medium configured to store instructions which, when executed by at least one processor of an electronic device for tracking a geographic position, causes the at least one processor to:
determine a duty cycle associated with a global navigation satellite system (GNSS) based on a determined state, wherein the duty cycle comprises one or more first time periods in which the GNSS module is active, and one or more second time periods in which the GNSS module is inactive;
obtain GNSS information indicating a first position of the electronic device during the one or more first time periods;
obtain sensor information indicating a second position of the electronic device during the one or more second time periods, the second position being relative to the first position; and
generate estimated missing path information which indicates at least one from among a distance traveled by the electronic device during the one or more second time periods, and a trajectory of the electronic device during the one or more second time periods based on the GNSS information and the sensor information.
